(19) United States
(12) Patent Application Publication
(10) Pub. No.: US 2026/0181555 A1
(43) Pub. Date: Jun. 25, 2026

(54) Multiple DRX Configurations for a User Equipment

(71) Applicant: Apple Inc., Cupertino, CA (US)

(72) Inventors: Ping-Heng KUO, London (GB); Fangli XU, Beijing (CN); Ralf ROSSBACH, Munich (DE)

(21) Appl. No.: 19/126,417

(22) PCT Filed: Nov. 3, 2022
(86) PCT No.: PCT/CN2022/129626

§ 371 Date: May 1, 2025

(51) Int. Cl. H04W 52/02; H04W 72/23

(52) U.S. Cl. CPC H04W 52/0235; H04W 72/23

(57) ABSTRACT

A user equipment (UE) is configured to receive, from a network, discontinuous configuration (DRX) configuration information comprising multiple DRX configurations including a plurality of default DRX configurations and at least one on-demand DRX configuration, and information indicating at least one association between at least one default DRX configuration and the at least one on-demand DRX configuration, activate the plurality of default DRX configurations, identify the at least one default DRX configuration is to be switched to the at least one associated on-demand DRX configuration, deactivate the at least one default DRX configuration and activate the at least one associated on-demand DRX configuration associated with the at least one deactivated default DRX configuration.

### TECHNICAL FIELD

This application relates generally to wireless communication systems, and in particular relates to multiple DRX configurations for a user equipment.

### BACKGROUND

In 3GPP standards, Discontinuous Reception (DRX) is an important mechanism for user equipment (UE) power saving. When DRX is implemented, the UE is configured to have periodic cycles of active and inactive intervals. During the active intervals (e.g., ON-Durations), the UE is configured to monitor the subframe for physical downlink control channel (PDCCH). Contrarily, during the inactive interval (e.g., OFF-Durations), the UE does not monitor for PDCCH. Thus, the UE is awake during the active intervals and back to sleep mode during inactive intervals.

Serving cells of a MAC entity may be configured by RRC in two DRX groups with separate DRX parameters. When RRC does not configure a secondary DRX group, there is only one DRX group and all serving cells belong to that one DRX group. When two DRX groups are configured, each serving cell is uniquely assigned to either of the two groups. The DRX parameters that are separately configured for each DRX group are: drx-onDurationTimer, drx-InactivityTimer. The DRX parameters that are common to the DRX groups are: drx-SlotOffset, drx-RetransmissionTimerDL, drx-RetransmissionTimerUL, drx-LongCycleStartOffset, drx-ShortCycle (optional), drx-ShortCycleTimer (optional), drx-HARQ-RTT-TimerDL, drx-HARQ-RTT-TimerUL, and uplinkHARQ-Mode (optional). More details such as definitions and applicability of these parameters can be found in 3GPP TS 38.321 and TS 38.331. Currently, only one set of parameters can be configured for a DRX group.

### SUMMARY

Some exemplary embodiments are related to a method performed by a user equipment (UE). The method includes receiving, from a network, discontinuous configuration (DRX) configuration information comprising multiple DRX configurations including a plurality of default DRX configurations and at least one on-demand DRX configuration, and information indicating at least one association between at least one default DRX configuration and the at least one on-demand DRX configuration, activating the plurality of default DRX configurations, identifying the at least one default DRX configuration is to be switched to the at least one associated on-demand DRX configuration, deactivating the at least one default DRX configuration and activating the at least one associated on-demand DRX configuration associated with the at least one deactivated default DRX configuration.

Other exemplary embodiments are related to a processor configured to receive, from a network, discontinuous configuration (DRX) configuration information comprising multiple DRX configurations including a plurality of default DRX configurations and at least one on-demand DRX configuration, and information indicating at least one association between at least one default DRX configuration and the at least one on-demand DRX configuration, activate the plurality of default DRX configurations, identify the at least one default DRX configuration is to be switched to the at least one associated on-demand DRX configuration, deactivate the at least one default DRX configuration and activate the at least one associated on-demand DRX configuration associated with the at least one deactivated default DRX configuration.

Still further exemplary embodiments are related to a user equipment (UE) having a transceiver configured to communicate with a network and a processor communicatively couple to the transceiver and configured to receive, from the network, discontinuous configuration (DRX) configuration information comprising multiple DRX configurations including a plurality of default DRX configurations and at least one on-demand DRX configuration, and information indicating at least one association between at least one default DRX configuration and the at least one on-demand DRX configuration, activate the plurality of default DRX configurations, identify the at least one default DRX configuration is to be switched to the at least one associated on-demand DRX configuration, deactivate the at least one default DRX configuration and activate the at least one associated on-demand DRX configuration associated with the at least one deactivated default DRX configuration.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows exemplary DRX configuration sets according to various exemplary embodiments.

FIG. 5 shows exemplary DRX configurations according to various exemplary embodiments.

FIG. 6 shows an exemplary signaling diagram for configuring a UE with multiple DRX configurations and instructing the UE to use one or more of the multiple DRX configurations according to various exemplary embodiments.

FIG. 7 shows an exemplary signaling diagram for autonomous UE DRX configuration switching according to various exemplary embodiments.

### DETAILED DESCRIPTION

The exemplary embodiments may be further understood with reference to the following description and the related appended drawings, wherein like elements are provided with the same reference numerals. The exemplary embodiments relate to a user equipment (UE) receiving multiple discontinuous reception (DRX) configurations from a base station to improve the power consumption of the UE, where each DRX configuration comprises indications of a set or a subset of parameters relating to DRX behavior of a UE.

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate type of electronic component.

The exemplary embodiments are also described with regard to a 5G NR network that supports extended Reality (XR). Those skilled in the art will understand that XR is an umbrella term for different types of realities and may generally refer to real-and-virtual combined environments and associated human-machine interactions generated by computer technology and wearables. To provide some examples, the term XR may encompass augmented reality (AR), mixed reality (MR) and virtual reality (VR). While the exemplary embodiments are described with reference to XR, it should be understood that the exemplary embodiments may be applied to any supplementary dynamic downlink resource assignment mechanism that may be utilized during a UE power saving mode. That is, the exemplary embodiments are not limited to scenarios where the UE is engaged in XR operations.

XR services may utilize multiple data flows in the uplink and/or downlink. For example, in the downlink, there may be a video stream, an audio stream and/or a data stream. In the uplink, there may be a control stream and/or a pose stream.

The exemplary embodiments are also described with regard to multiple DRX configuration operation. Those skilled in the art will understand that DRX generally refers to a UE power saving mechanism. A DRX cycle may be configured with a time duration during which the UE is scheduled to utilize an active mode of monitoring PDCCH during ON-Durations and no monitoring PDCCH during OFF-Durations. During the OFF-Durations, the UE may have the opportunity to utilize a sleep mode and conserve power by not actively monitoring PDCCH.

In the exemplary embodiments, a DRX configuration may be referred to as a set or a subset of parameters that instructs DRX behavior of a UE, such as for example, how often the UE should wake up and enter DRX ON-Duration (DRX cycle periodicity), and how long it should stay active in the DRX ON-Duration, how often the UE should periodically enter DRX OFF-Duration, and how long it should stay in inactive in the DRX OFF-Duration, etc.

The exemplary embodiments introduce multiple DRX configurations for the UE. Some DRX configurations may be referred to as “default DRX configurations” and may be used to support a number of static traffic flows based on the traffic periodicity. For example, video traffic of an XR application may have some known or expected characteristics such as a packet periodicity. A default DRX configuration may be used when this type of static traffic flow is being exchanged between the UE and the network. Similarly, the audio traffic and/or pose traffic of an XR application may also have a known or expected packet periodicity and a default DRX configuration (e.g., a second or third default DRX configuration) may be used when this type of static traffic flow is being exchanged between the UE and the network. It should be understood that the use of the XR audio, video and traffic flows is only exemplary and the default DRX configurations may be used for any type of traffic flows.

The exemplary embodiments also introduce one or more “on-demand DRX configurations.” These on-demand DRX configurations may further support dynamic adjustments of DRX parameters such as ON/OFF-durations to improve or optimize the power saving performance in certain conditions of a traffic flow such as jitter. Specifically, the on-demand DRX configurations may be used as a temporary replacement for the default DRX configuration for a traffic flow when the traffic flow is experiencing an issue such as jitter, or when the UE intends to transmit/receive packets with different delay budget. When the issue is resolved, the UE may transition back to the default DRX configuration, either autonomously or based on further instruction from the network.

Throughout this description, the information that is provided from the network (e. g., gNB) to the UE may be configured in various manners. In some exemplary embodiments, the network may configure the information via transmission mechanisms, e.g., Radio Resource Control (RRC) signaling, Medium Access Control (MAC) signaling, etc. Thus, when a specific example of a transmission mechanism is provided in the following example, it should be understood that the example is merely for illustrative purposes and other reporting mechanisms may be used.

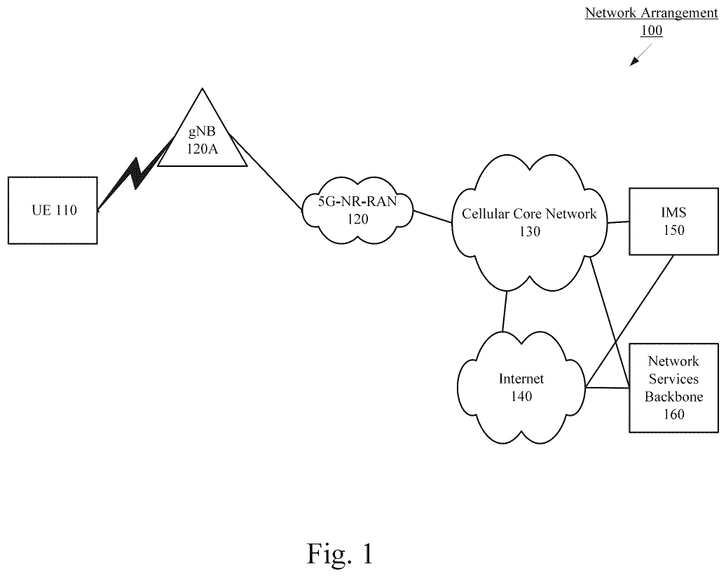

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IOT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e. g., 5G cloud RAN, a next generation RAN (NG-RAN), a long term evolution (LTE) RAN, a legacy cellular network, a WLAN, etc. ) and the UE 110 may also communicate with networks over a wired connection. With regard to the exemplary embodiments, the UE 110 may establish a connection with the 5G NR RAN 120.

Therefore, the UE 110 may have a 5G NR chipset to communicate with the NR RAN 120.

The 5G NR RAN 120 may be a portion of a cellular network that may be deployed by a network carrier (e. g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

The UE 110 may connect to the 5G NR-RAN 120 via the qNB 120A. Those skilled in the art will understand that any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific base station (e.g., gNB 120A).

However, as mentioned above, reference to the 5G NR-RAN 120 is merely for illustrative purposes and any appropriate type of RAN may be used.

The network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e. g., servers, network storage arrangements, etc.) that implement a suite of services that may be used to extend the functionalities of the UE 110 in communication with the various networks.

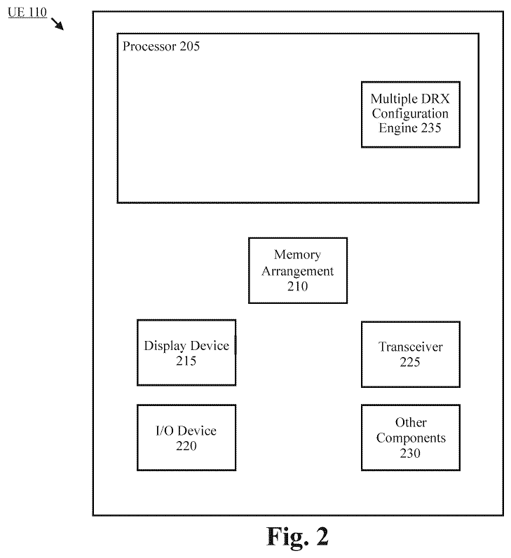

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a multiple DRX configuration engine 235. The multiple DRX configuration engine 235 may perform various operations related to the exemplary implementation of various DRX configurations described herein. These operations may include, but are not limited to, receiving multiple DRX configuration information, implementing DRX configuration mapping, implementing semi-static switching in the DRX configuration, switching autonomously from one DRX configuration to another DRX configuration and indicating preferred DRX configuration using UE assistance information (UAI). Each of these various operations will be described in greater detail below.

The above referenced engine 235 being an application (e. g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs.

The display device 215 and the I/O device 220 may be separate components or integrated together such as a touchscreen. The transceiver 225 may be a hardware component configured to establish a connection with the 5G NR-RAN 120 and/or any other appropriate type of network. Accordingly, the transceiver 225 may operate on a variety of different frequencies or channels (e. g., set of consecutive frequencies).

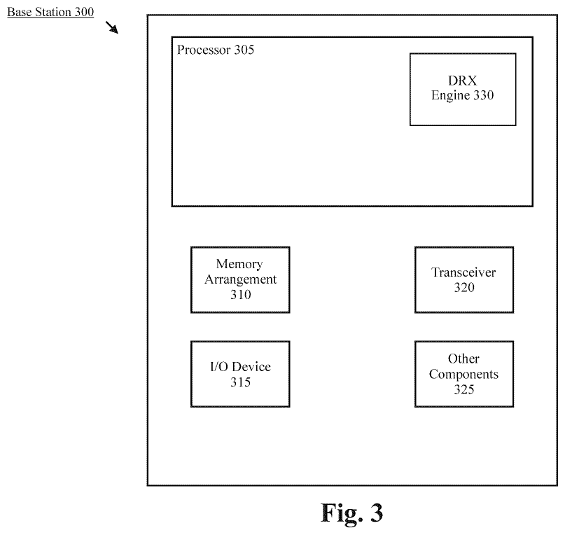

FIG. 3 shows an exemplary base station 300 according to various exemplary embodiments. The base station 300 may represent any access node (e.g., gNB 120A, etc.) through which the UE 110 may establish a connection and manage network operations.

The base station 300 may include a processor 305, a memory arrangement 310, an input/output (I/O) device 315, a transceiver 320, and other components 325. The other components 325 may include, for example, a battery, a data acquisition device, ports to electrically connect the base station 300 to other electronic devices, etc.

The processor 305 may be configured to execute a plurality of engines of the base station 300. For example, the engines may include a DRX engine 330. The DRX engine 330 may perform various operations related to the exemplary multiple DRX configuration information described herein. The operations may include but are not limited to, transmitting DRX capability information, transmitting DRX configuration mapping, transmitting DRX switching configuration information, receiving DRX autonomous switching information and receiving UE assistance information (UAI). Each of these various operations will be described in greater detail below.

The above noted engine 330 being an application (e.g., a program) executed by the processor 305 is only exemplary. The functionality associated with the engines 330, 335 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the system 100. The transceiver 320 may operate on a variety of different frequencies or channels (e.g., set of consecutive frequencies). Therefore, the transceiver 320 may include one or more components (e.g., radios) to enable the data exchange with the various networks and UEs.

As described above, the exemplary embodiments provide multiple DRX configurations (default and on-demand configurations) that may be used when the UE is executing an application that has a particular traffic flow or traffic flows. However, it should be understood that the DRX configuration and the traffic flows are different concepts. As described above, the DRX configurations provide cycles where the UE is in an ON-Duration (e.g., actively receiving signaling from the network) or an OFF-Duration (e. g., where the UE is not monitoring for signaling transmitted by the network). The traffic flow is the actual exchange of data between the UE and the network. However, there may be a relationship defined between these two concepts where a particular DRX configuration is more suited for a particular type of traffic flow based on the characteristics of the DRX cycle implemented by the DRX configuration and the characteristics of the traffic flow such as packet periodicity. The exemplary embodiments take advantage of this relationship by configuring the DRX cycle(s) of the UE to be the DRX cycle(s) that are suited to the particular traffic flow(s) that are currently being used by the UE.

In the exemplary embodiments, a DRX configuration (e. g., a default DRX configuration or an on-demand DRX configuration) comprises a set or a subset of DRX parameters. In cases where an on-demand DRX configuration comprises only a subset of DRX parameters, the UE may assume the parameters not in the subset are the same as the default DRX configuration.

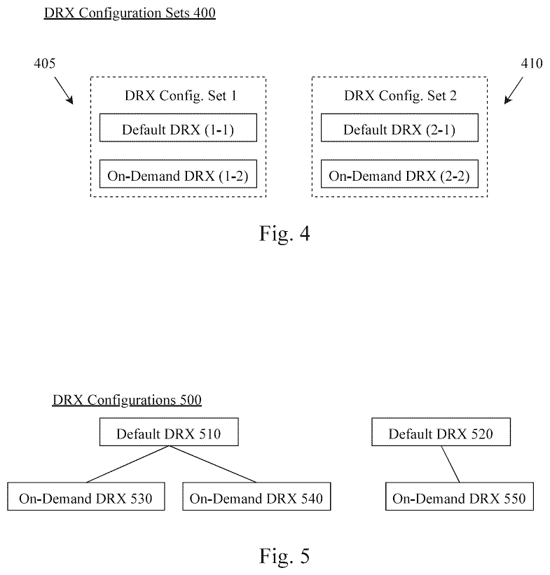

FIG. 4 shows exemplary DRX configuration sets 400 according to various exemplary embodiments. In this example, there are two DRX configuration sets, DRX configuration set 405 and DRX configuration set 410. It should be understood that the use of two DRX configuration sets is only exemplary and there may be any number of DRX configuration sets. The DRX configuration sets 400 may be signaled to the UE in DRX configuration information, e.g., RRC signaling, MAC-CE signaling, etc.

In this example, each DRX configuration set 405 and 410 comprises a default DRX configuration and an on-demand DRX configuration. It should also be understood that the DRX configuration sets 405 and 410 may have more than one on-demand DRX configuration and the different DRX configurations sets 405 and 410 may have different numbers of on-demand DRX configurations.

As described above, the default DRX configuration may be a DRX configuration that is designed to be suitable for use with one or more particular static traffic flow(s). On the other hand, the one or more on-demand DRX configurations that are included in the same DRX configuration set as a default DRX configuration may be designed to handle issues that may arise with the traffic flow, such as timing mismatch between packet arrival and DRX ON-duration.

To provide a specific example, it may be considered that the DRX configuration set 405 includes a default DRX configuration that is optimized for the video traffic flow of an XR application. Similarly, the on-demand DRX configuration that is included in the same DRX configuration set may be designed to handle any issues that arise in the video traffic flow. Thus, the UE may be configured to use the DRX configuration set 405 when an application having XR video traffic is being executed by the UE.

Similarly, the DRX configuration set 410 may include a default DRX configuration and one or more on-demand DRX configurations that are suited for a different traffic flow, e.g., audio traffic or pose traffic of an XR application.

In the exemplary embodiments, only one DRX configuration from each DRX configuration set 405 should be active at a given time. For example, if the default DRX configuration of the DRX configuration set 405 is active, no other on-demand DRX configurations of the DRX configuration set 405 should be active. On the other hand, the exemplary embodiments allow multiple DRX configurations from different DRX configuration sets to be active at a given time. For example, the default DRX configuration of the DRX configuration set 405 and the on-demand DRX configuration of the DRX configuration set 410 may be active at the same time.

It should be understood that the default DRX configurations are the DRX configurations that the UE will use by default when instructed by the network to apply a particular DRX configuration set for a particular traffic flow. For example, the network may configure the UE to use the DRX configuration set 405 for XR video traffic. Without any further instruction by the network, the UE will use the default DRX configuration of the DRX configuration set 405 for the XR video traffic. The network may configure the UE to use the DRX configuration set 405 for XR video traffic by sending an indication that includes a DRX configuration set identification so the UE may identify the individual DRX configuration set to which the network is referring.

The network may also switch the currently used DRX configuration of a DRX configuration set by sending a message to the UE, e. g., using a downlink (DL) MAC-CE. For example, if the UE is currently using the default DRX configuration of the DRX configuration set, the message may indicate the UE should switch to one of the one or more on-demand DRX configurations. When there is more than one on-demand DRX configuration, the message may include an on-demand DRX configuration identification for the on-demand DRX configuration to which the network wants the UE to switch. It should be understood that the message may also instruct the UE to return to using the default DRX configuration when currently using an on-demand configuration or to switch to a different one of the on-demand configurations when there are more than one available.

FIG. 5 shows exemplary DRX configurations 500 according to various exemplary embodiments. Unlike the example of FIG. 4, in FIG. 5 the DRX configurations are not grouped into sets. Rather, there are any number of default DRX configurations, which in this example is two, default DRX configuration 510 and default DRX configuration 520. In addition, there are any number of on-demand DRX configurations, which in this example is three, on-demand DRX configuration 530, on-demand DRX configuration 540 and on-demand DRX configuration 550. The DRX configurations 500 may be signaled to the UE in DRX configuration information, e.g., RRC signaling, MAC-CE signaling, etc.

In this example, there are lines that go from default DRX configuration 510 to on-demand DRX configuration 530 and on-demand DRX configuration 540. This represents that the on-demand DRX configuration 530 and on-demand DRX configuration 540 are associated with the default DRX configuration 510. This association between default and on-demand DRX configurations may be provided to the UE by configuration information. The association means that the network may switch the UE from using the default DRX configuration to any of the associated on-demand DRX configurations.

Similarly, there is a line that goes from default DRX configuration 520 to on-demand DRX configuration 550 indicating that these two DRX configurations are associated. It is also possible that a default DRX configuration is not associated with any on-demand DRX configurations, e.g., the UE will not expect to switch from the default DRX configuration to an on-demand DRX configuration. Furthermore, an on-demand DRX configuration may also be associated with more than one default DRX configuration. For example, while not shown in FIG. 5, it is possible that on-demand DRX configuration 540 is also associated with the default DRX configuration 520.

The network may associate one or more traffic flows with a default DRX configuration and by implication the associated on-demand DRX configurations. To provide a specific example, the network may configure the UE with information indicating the UE should use the default DRX configuration 510 for XR video traffic and the default DRX configuration 520 for XR audio traffic, e.g., through the use of a default DRX configuration identification. This would also indicate to the UE the on-demand DRX configurations that may be used for the corresponding traffic flows because the UE is configured with the on-demand DRX configurations that are associated with the default DRX configurations.

The network may also switch the currently used DRX configuration by sending a message to the UE, e.g., using a downlink (DL) MAC-CE. For example, for a particular traffic flow, if the UE is currently using the default DRX configuration 510, the message may indicate the UE should switch to one of the on-demand DRX configuration 530 or the on-demand DRX configuration 540, e.g., the on-demand configurations associated with the default UE configuration 510. As shown by this example, when there is more than one associated on-demand DRX configuration, the message may include an on-demand DRX configuration identification for the on-demand DRX configuration to which the network wants the UE to switch. If there is only one associated on-demand DRX configuration, the message may be limited to a switch command because the UE will know that there is only one possible on-demand DRX configuration to which it can switch. It should be understood that the message may also instruct the UE to return to using the default DRX configuration when currently using an on-demand configuration or to switch to a different one of the on-demand configurations when there are more than one available.

It should be understood that the default DRX configurations are the DRX configurations that the UE will use by default when instructed by the network without any further instruction by the network.

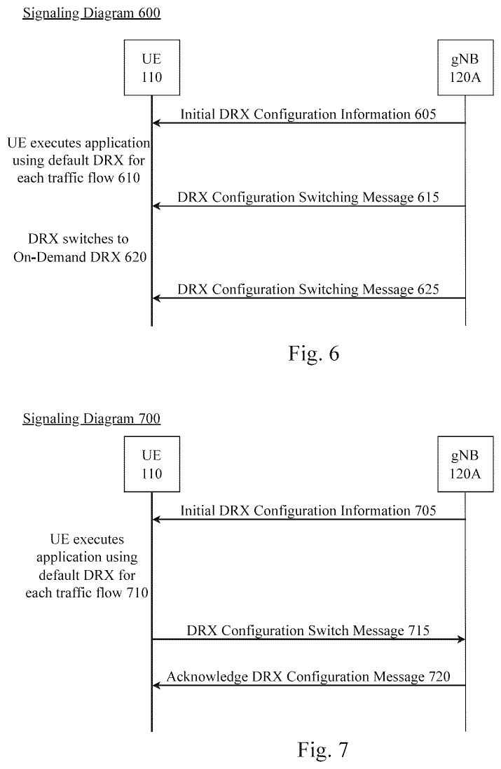

FIG. 6 shows an exemplary signaling diagram 600 for configuring a UE with multiple DRX configurations and instructing the UE to use one or more of the multiple DRX configurations according to various exemplary embodiments. The signaling diagram 600 is described with regard to the network arrangement 100 of FIG. 1, the UE 110 of FIG. 2 and the base station 300 (e.g., gNB 120A) of FIG. 3.

In 605, the UE 110 receives initial DRX configuration information from the network, e.g., gNB 120A. The initial DRX configuration information may include the DRX configuration sets and related information as described above with reference to FIG. 4 or the DRX configurations and related information as described above with reference to FIG. 5. For example, when the initial DRX configuration information includes the DRX configuration sets, the configuration information received by the UE may include, but is not limited to, the identification of each DRX configuration set, the default DRX configuration and the DRX parameters of the default DRX configuration of each DRX configuration set, the identification of the default DRX configuration, the one or more on-demand configurations and the DRX parameters for each DRX configuration set, the identification of each of the one or more on-demand DRX configurations, an association between a traffic flow and the DRX configuration sets, etc. From this list it should be seen that the configuration information may include any of the information that was described above for the DRX configuration sets. Similarly, when the initial DRX configuration information includes the DRX configurations as shown by example in FIG. 5, the configuration information may include any of the information described above.

In some embodiments, the DRX configuration information 605 may be provided to the UE 110 in one or more radio resource control (RRC) messages. In other embodiments, the DRX configuration information may be provided to the UE 110 in one or more MAC-CEs. However, the exemplary embodiments are not limited to RRC messages or MAC CEs, the DRX configuration information may be provided to the UE 110 in any appropriate manner.

In 610, the UE 110 may execute an application that has one or more traffic flows. As described above, unless otherwise instructed by the network, the UE will use the default DRX configuration corresponding to the one or traffic flows.

The gNB 120A (or the network) may determine that there is an issue with one or more of the traffic flows. The issue with the traffic flow may be better resolved by using an on-demand DRX configuration rather than the default DRX configuration. Thus, in 615, the gNB 120A may dynamically activate one of the on-demand DRX configurations that is associated with the traffic flow experiencing the issue. This may be accomplished by the gNB 120A sending a DRX switching message to the UE 110 indicating the UE should switch from the default DRX configuration to the associated on-demand DRX configuration. Examples of the information that may be included in the message (e.g., DRX configuration set identification, default DRX configuration identification, on-demand DRX configuration identification, etc.) were described above. The message may be sent, for example, via a MAC CE.

In 620, the UE 110 may switch the DRX configuration for the identified traffic flow to one of the one or more on-demand DRX configurations based on the information received in the DRX switching message.

In 625, the gNB 120A send another DRX configuration switching message indicating the UE 110 should fall back to the default DRX configuration or switch to a different one of the on-demand DRX configurations. For example, if the gNB 120A (or network) determine that the issue with the traffic is resolved or no longer exist at least temporarily, the DRX configuration switching message 625 may indicate the UE 110 should fall back to the default DRX configuration. If the gNB 120A (or network) determine that the issue with the traffic is not resolved or another issue has arisen, the DRX configuration switching message 625 may indicate the UE 110 should switch to a different on-demand DRX configuration associated with the traffic flow.

In some exemplary embodiments, DRX configuration switching message 625 may not be used to indicate the UE 110 should fall back to the default DRX configuration. For example, the initial DRX configuration may indicate a time after which an on-demand DRX configuration should be switched back to the associated default DRX configuration. In another example, the DRX configuration switching message 615 may include a time after which an on-demand DRX configuration should be switched back to the associated default DRX configuration.

The exemplary embodiments further introduce techniques for semi-static switching for the DRX configurations according to various exemplary embodiments. In these exemplary embodiments, the UE 110 may be configured to switch from a default DRX configuration to an on-demand DRX configuration in a pre-configured time pattern. For example, the gNB 120A may configure the UE 110 with DRX configuration controlled by a preconfigured time pattern that switches the DRX configuration based on the time interval defined in the preconfigured time pattern. The time pattern may include different time intervals at which the UE 110 may be configured to use a default DRX configuration or switch to an on-demand DRX configuration.

FIG. 7 shows an exemplary signaling diagram 700 for autonomous UE DRX configuration switching according to various exemplary embodiments. The signaling diagram 700 is described with regard to the network arrangement 100 of FIG. 1, the UE 110 of FIG. 2 and the base station 300 (e.g., gNB 120A) of FIG. 3.

The operations 705 and 710 are similar to the operations 605 and 610 described above with reference to FIG. 6 and will not be described again.

In this exemplary embodiment, it may be considered that the UE 110 experiences some triggering event(s) that may require the UE 110 to switch from the current default DRX configuration to a corresponding on-demand DRX configuration to accommodate the triggering event. For example, in an uplink transmission, jitter may be present in the uplink which may only be known to the UE 110. Based on the jitter, the UE 110 may determine to switch from the default DRX configuration to a corresponding on-demand DRX configuration to accommodate the jitter. As described above, the UE 110 knows the available on-demand DRX configurations corresponding to the default DRX configuration based on the DRX configuration information.

Thus, in 715, the UE 110 may transmit a DRX configuration switch message to the gNB 120A alerting the gNB 120A of a possible autonomous switch by the UE 110 from the default DRX configuration to an on-demand DRX configuration. The DRX configuration switch message may be sent via uplink signal (e.g., MAC-CE, uplink control information (UCI) ) to notify the gNB 120A of the DRX configuration switching. In some exemplary embodiments, the UE 110 may notify the gNB 120A of the DRX configuration switch before implementing the switch. In other exemplary embodiments, the UE 110 may notify the gNB 120A of the DRX configuration switch after implementing the switch.

In 720, the gNB 120A may transmit a DRX configuration message acknowledgement to the UE 110 to acknowledge and confirm the DRX configuration switch. This operation may be performed when the UE 110 notifies the gNB 120A prior to implementing the DRX configuration switch. This allows the gNB 120A to send a confirmation signal acknowledging the DRX configuration switch. Based on the confirmation signal, the UE 110 may autonomously switch the DRX configuration to accommodate the current conditions experienced by the UE 110. In other exemplary embodiments, the gNB 120A may send a message indicating that the UE 110 should not perform the switch.

The exemplary embodiments further introduce techniques for UE assistance information (UAI) for DRX configuration according to various exemplary embodiments. According to existing 3GPP specifications, the UE 110 may be configured to transmit UAI to the gNB 120A to indicate its preference on DRX configuration settings. Thus, in the exemplary embodiment, when the UE 110 is configured with multiple DRX configurations that are not classified as either default or on-demand, the UE 110 may send UAI to indicate which DRX configuration(s) the UE 110 may prefer to use as default or on-demand. In other exemplary embodiments, when the multiple DRX configurations are classified into multiple DRX configuration sets as described with reference to FIG. 4, the UE 110 may send UAI that includes the identifications of the DRX configuration set, the default DRX configuration and/or the on-demand DRX configuration that the UE 110 prefers. In further exemplary embodiments, when the multiple DRX configurations are classified into default and on-demand DRX configurations as described with reference to FIG. 5, the UE 110 may send UAI that includes the identifications of the default DRX configuration and/or the on-demand DRX configuration which the UE 110 may prefer to modify. In additional exemplary embodiments, the UE 110 may send UAI that indicates which DRX configuration can be switched from default DRX configuration to on-demand DRX configuration and vice versa.

### EXAMPLES

In a first example, a processor is configured to receive, from a network, discontinuous configuration (DRX) configuration information comprising multiple DRX configurations including a plurality of default DRX configurations and at least one on-demand DRX configuration, and information indicating at least one association between at least one default DRX configuration and the at least one on-demand DRX configuration, activate the plurality of default DRX configurations, identify the at least one default DRX configuration is to be switched to the at least one associated on-demand DRX configuration, deactivate the at least one default DRX configuration and activate the at least one associated on-demand DRX configuration associated with the at least one deactivated default DRX configuration.

In a second example, the processor of the first example, wherein the at least one default DRX configuration and the at least one associated on-demand DRX configuration comprise a DRX configuration set, wherein only a single DRX configuration of the DRX configuration set is active at a given time.

In a third example, the processor of the second example, wherein the identifying is based on at least an identification of the DRX configuration set.

In a fourth example, the processor of the second example, wherein the identifying is based on at least an identification of the at least one associated on-demand DRX configuration.

In a fifth example, the processor of the second example, further configured to transmit UE assistance information (UAI) to indicate a DRX configuration preference, wherein the UAI comprises an identification of the DRX configuration set, an identification of the at least one default DRX configuration or an identification of the at least one associated on-demand DRX configuration.

In a sixth example, the processor of the first example, further configured to determine to switch from the at least one associated on-demand DRX configuration to the at least one default DRX configuration based on receiving a message, a predetermined condition or a predetermined timing configuration, deactivate the at least one associated on-demand configuration and activate the at least one default DRX configuration.

In a seventh example, the processor of the first example, wherein the at least one associated on-demand DRX configuration comprises a plurality of associated on-demand DRX configurations.

In an eighth example, the processor of the first example, wherein the associated on-demand DRX configuration is associated with more than one default DRX configurations.

In a ninth example, the processor of the first example, wherein the identifying is based on at least an identification of the at least one default DRX configuration.

In a tenth example, the processor of the first example, wherein the identifying is based on at least an identification of the at least one associated on-demand DRX configuration.

In an eleventh example, the processor of the first example, wherein the DRX configuration information is received via a medium access control element (MAC-CE) or radio resource control (RRC) signaling.

In a twelfth example, the processor of the first example, wherein the DRX configuration information comprises a preconfigured timing pattern indicating when the UE should switch from the at least one default DRX configuration to the at least one associated on-demand DRX configuration.

In a thirteenth example, the processor of the first example, wherein the identifying is based on a predetermined trigger event without any input from the network.

In a fourteenth example, the processor of the thirteenth example, further configured to send a message to the network indicating the UE has determined to switch from the at least one default DRX configuration to the at least one associated on-demand DRX configuration.

In a fifteenth example, the processor of the thirteenth example, wherein the predetermined trigger event comprises jitter in an uplink (UL).

In a sixteenth example, the processor of the first example, further configured to transmit UE assistance information (UAI) to indicate a DRX configuration preference, wherein the UAI comprises a DRX configuration identification of the at least one default DRX configuration or the at least one associated on-demand DRX configuration.

In a seventeenth example, the processor of the first example, wherein each of the plurality of default DRX configurations and the at least one on-demand DRX configuration comprises a set or a subset of parameters relating to DRX behavior of the UE.

in an eighteenth example, the processor of the seventeenth example, wherein, when the at least one on-demand DRX configuration is activated and comprises a subset of parameters, the UE continues to use parameters that are not in the subset from the at least one default DRX configuration associated with the at least one on-demand DRX configuration.

In a nineteenth example, a user equipment (UE) comprising a transceiver configured to communicate with a network and the processor of any of the first through eighteenth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as ios, Android, etc. The exemplary embodiments of the above described methods may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A method performed by a user equipment (UE), comprising:
receiving, from a network, discontinuous reception cycle (DRX) configuration information comprising multiple DRX configurations including a plurality of default DRX configurations and at least one on-demand DRX configuration, and information indicating at least one association between at least one default DRX configuration and the at least one on-demand DRX configuration;
activating the plurality of default DRX configurations;
identifying the at least one default DRX configuration is to be switched to the at least one on-demand DRX configuration;
deactivating the at least one default DRX configuration; and
activating the at least one on-demand DRX configuration associated with the at least one default DRX configuration.

2. The method of claim 1, wherein the at least one default DRX configuration and the at least one on-demand DRX configuration comprise a DRX configuration set, wherein only a single DRX configuration of the DRX configuration set is active at a given time.

3. The method of claim 2, wherein the identifying is based on at least an identification of the DRX configuration set.

4. The method of claim 2, wherein the identifying is based on at least an identification of the at least one on-demand DRX configuration.

5. The method of claim 2, further comprising:
transmitting UE assistance information (UAI) to indicate a DRX configuration preference, wherein the UAI comprises an identification of the DRX configuration set, an identification of the at least one default DRX configuration or an identification of the at least one on-demand DRX configuration.

6. The method of claim 1, further comprising:
determining to switch from the at least one on-demand DRX configuration to the at least one default DRX configuration based on receiving a message, a predetermined condition or a predetermined timing configuration;
deactivating the at least one on-demand DRX_ configuration; and
activating the at least one default DRX configuration.

7. The method of claim 1, wherein the at least one on-demand DRX configuration comprises a plurality of on-demand DRX configurations.

8. The method of claim 1, wherein the at least one on-demand DRX configuration is associated with more than one default DRX configurations.

9. The method of claim 1, wherein the identifying is based on at least an identification of the at least one default DRX configuration.

10. The method of claim 1, wherein the identifying is based on at least an identification of the at least one on-demand DRX configuration.

11. The method of claim 1, wherein the DRX configuration information is received via a medium access control element (MAC-CE) or radio resource control (RRC) signaling.

12. The method of claim 1, wherein the DRX configuration information comprises a preconfigured timing pattern indicating when the UE is to switch from the at least one default DRX configuration to the at least one on-demand DRX configuration.

13. The method of claim 1, wherein the identifying is based on a predetermined trigger event without any input from the network.

14. The method of claim 13, further comprising:
sending a message to the network indicating the UE has determined to switch from the at least one default DRX configuration to the at least one on-demand DRX configuration.

15. The method of claim 13, wherein the predetermined trigger event comprises jitter in an uplink (UL).

16. The method of claim 1, further comprising:
transmitting UE assistance information (UAI) to indicate a DRX configuration preference, wherein the UAI comprises a DRX configuration identification of the at least one default DRX configuration or the at least one on-demand DRX configuration.

17. The method of claim 1, wherein each of the plurality of default DRX configurations and the at least one on-demand DRX configuration comprises a set or a subset of parameters relating to DRX behavior of the UE.

18. The method of claim 17, wherein, when the at least one on-demand DRX configuration is activated and comprises the subset of parameters, the UE continues to use parameters that are not in the subset from the at least one default DRX configuration associated with the at least one on-demand DRX configuration.

19. A processor configured to:
receive, from a network, discontinuous reception cycle (DRX) configuration information comprising multiple DRX configurations including a plurality of default DRX configurations and at least one on-demand DRX configuration, and information indicating at least one association between at least one default DRX configuration and the at least one on-demand DRX configuration;
activate the plurality of default DRX configurations;
identify the at least one default DRX configuration is to be switched to the at least one on-demand DRX configuration;
deactivate the at least one default DRX configuration; and
activate the at least one on-demand DRX configuration associated with the at least one default DRX configuration.

20. A user equipment (UE), comprising a transceiver configured to communicate with a network; and
a processor communicatively couple to the transceiver and configured to:
receive, from the network, discontinuous reception cycle (DRX) configuration information comprising multiple DRX configurations including a plurality of default DRX configurations and at least one on-demand DRX configuration, and information indicating at least one association between at least one default DRX configuration and the at least one on-demand DRX configuration;
activate the plurality of default DRX configurations;
identify the at least one default DRX configuration is to be switched to the at least one on-demand DRX configuration;
deactivate the at least one default DRX configuration; and
activate the at least one on-demand DRX configuration associated with the at least one default DRX configuration.
